(19) United States
(12) Patent Application Publication
(10) Pub. No.: US 2014/0352351 A1
(43) Pub. Date: Dec. 4, 2014

(54) REFRIGERATION SYSTEM WITH DUAL REFRIGERANTS AND LIQUID WORKING FLUIDS

(71) Applicant: H & C Scientific Resources International, LLC, Longmont, CO (US)

(72) Inventor: Yanjie Xu, Longmont, CO (US)

(73) Assignee: H & C Scientific Resources International, LLC, Longmont, CO (US)

(21) Appl. No.: 14/288,345

(22) Filed: May 27, 2014

Related U.S. Application Data
(60) Provisional application No. 61/827,890, filed on May 28, 2013.

(51) Int. Cl. C09K 5/16; F25B 15/00; F25B 1/00

(52) U.S. Cl. CPC C09K 5/16; F25B 1/005; F25B 15/00; F25B 2315/00; C09K 2205/134; C09K 2205/106
USPC 62/476; 62/498; 252/67; 252/68

(57) ABSTRACT

In one embodiment, the present invention relates to the use of ionic liquids and gas refrigerants in a refrigerant composition in a temperature adjustment system, such as a refrigeration system.

### RELATED APPLICATION

This application claims the benefit of U.S. Provisional Application No. 61/827,890 filed May 28, 2013.

### FIELD OF THE INVENTION

The present invention is broadly directed to novel compositions of refrigerants or refrigerant compositions and apparatus for refrigeration systems, for example, to increase the energy efficiency of such systems using such compositions.

### BACKGROUND OF THE INVENTION

Refrigeration, air conditioning and heat pump systems are widely used in domestic and industrial applications. Methods for refrigeration include cyclic and non-cyclic refrigeration cycle. Cyclic refrigeration can be classified as vapor cycle and gas cycle. Vapor cycle refrigeration can further be classified as vapor compression refrigeration and vapor absorption refrigeration. Most refrigeration and air conditioning systems employ vapor compression systems to cool air. These systems are made up of an evaporator, condenser, and compressor. For example, refrigerator appliances are based on a vapor-compression refrigeration technique. In such a refrigeration technique, a refrigerant serves as the medium that absorbs and removes heat from the space to be cooled, and transfers the heat elsewhere for rejection. The choice of the refrigerant is critical for the efficient operation of a vapor compression system. In a normal vapor compression system, the phase change of refrigerants is achieved by compression powered by electricity, and the power consumption and operating cost is high.

There is an ongoing critical need to find a more energy efficient and environmentally friendly refrigeration system that can solve both the cost and energy efficiency issues.

There are extensive research efforts devoted to developing new refrigerants or alternative refrigeration systems that can reduce greenhouse gas emissions and/or energy consumption. Alternative refrigeration systems include thermo acoustic, thermoelectric, magneto caloric, indirect cooling, zeolite cooling, thermo-acoustic refrigeration, thermionic refrigeration, magnetic cooling and Stirling cycle cooling system. All of these technologies have been demonstrated, but are not yet as effective as vapor-compression systems. A number of problems remain to be solved before any of these can be widely adopted.

Ionic Liquids (“ILs”) have been explored for applications in refrigeration, especially as an absorption media for vapor absorption refrigeration. ILs are a class of low-temperature molten salts, which are composed of an organic cation and an inorganic anion. Recently, ILs have been used as organic green solvents in catalysis, separation process, electrochemistry, and many other industries for their unique physical and chemical properties, such as negligible vapor pressure, negligible flammability and thermal stability, low melting temperature and liquid state over a wide temperature range, and good solubility.

ILs may be employed as the working fluids of absorption refrigeration systems. For example, one desirable characteristic of ILs is the large capacity of ILs to dissolve CO₂, so that the ILs can be used as a refrigerant in an absorption cycle. While the use of ILs as the working fluids can lead to benefits such as less crystallization, less corrosion, low toxicity, and nonflammability, ILs require higher circulation ratio, which increases the energy consumption of heating and pumping processes. So the overall Coefficient of Performance is lower than that of traditional absorption cycles.

Additionally, many countries have stopped the use of hydrochlorofluorocarbon refrigerants, and ammonia is being considered for residential applications. Ammonia does not contribute to global warming; it has a global-warming potential rating of zero, and it is a superb refrigerant. However, ammonia is mildly toxic and slightly combustible, so its application primarily is in large industrial installations and food preservation.

Accordingly, there is a continuing need to identify a refrigeration composition or mixture that provides improved energy efficiency, enhanced performance, cost effectiveness, and at the same time is safe, non-corrosive and environmentally friendly.

### SUMMARY OF THE INVENTION

In one aspect of the present application, there is provided a refrigeration system comprising a refrigerant composition and an apparatus, wherein the refrigerant composition comprises at least one gas refrigerants and a working liquid or fluid; wherein the apparatus comprises:

(a) an absorption/reaction chamber configured to receive the one or more gas refrigerants that is passed from a compressor into the absorption/reaction chamber;

(b) an evaporator/desorber chamber configured to pass an unsaturated working liquid to the absorption/reaction chamber;

wherein the one or more gas refrigerants reversibly react in the absorption/reaction chamber under high pressure and absorbed by the unsaturated working liquid to form a saturated ionic liquid;

(c) a hot side heat exchanger configured to be connected to the absorption/reaction chamber;

(d) a pressure reduction device configured to receive the saturated working liquid from the absorption/reaction chamber and to pass the saturated ionic liquid to the evaporator/desorption chamber;

wherein the gas refrigerant vaporizes from the saturated working liquid under low pressure in the evaporator/desorption chamber to form the unsaturated working liquid;

(e) a cold side heat exchanger configured to be connected to the evaporator/desorption chamber; and

(f) a conduit configured to receive the gas refrigerant from the evaporator/desorption chamber and to return the gas refrigerant to the compressor.

In one aspect of the above system, the gas refrigerants is passed from the compressor through a sparger into the absorption/reaction chamber. In one aspect of the composition disclosed herein, the alcohol is a linear or branched C₁₋₂₀ alcohol, such as an alcohol selected from the group consisting of methanol, ethanol, propanol, isopropanol, butanol, pentanol, hexanol, heptanol, octanol etc. . . . , and mixtures thereof.

In one aspect of the present application, there is provided a refrigerant composition for a refrigeration system, wherein the composition comprises a dual gas refrigerants that can undergo reversible reactions, and further comprising a liquid working fluid. In one aspect, the working fluid is an IL.

In one embodiment, there is provided a refrigerant composition for use in a refrigeration system comprising:
a) a working fluid selected from the group consisting of water, alcohol and an IL compound of the formula 1:

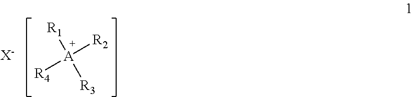

wherein A is selected from N, P or S; and wherein
   i) when A is N, each R₁, R₂, R₃ and R₄ independently form a double bond with N and an adjacent R₁, R₂, R₃ or R₄ group or are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂; or wherein R₁, R₂ and R₃ together with N form a heteroaromatic or R₁ and R₂ together with N form a heterocyclic ring each unsubstituted or substituted by a group selected from halo, nitro, trifluoromethyl, trifluoromethoxy, methoxy, carboxy, —NH₂, —OH, —SH, —NHCH₃, —N(CH₃)₂, —SMe, cyano, (C₁-C₃)alkyl, aryl, (C₃-C₆)cycloalkyl, aryl(C₁-C₃)alkyl and heteroaryl;
   ii) when A is S, R₁, R₂, R₃ and R₄ are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂; and
   iii) when A is P, R₁, R₂, R₃ and R₄ are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂; and
b) a gas refrigerant comprising one acidic gas and one basic gas that can undergo reversible reactions. The basic gas refrigerant may be selected from a group consisting of methylamine, ethylamine and ammonia; or any combination thereof. As used herein, a combination also means a mixture of any 2, 3, 4 or more gas refrigerants or ILs. In one embodiment, the acidic gas refrigerant may be selected from a group consisting of carbon dioxide, nitrous dioxide and sulfur dioxide; or any combination thereof. Ammonia and CO₂ as dual gas refrigerants are preferred.

In one aspect of the above compound, at least one of R₁, R₂, R₃ and R₄ is selected from the group consisting of (C₁-C₁₀)alkyl substituted with one —Cl, —Br, —I, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —OC(O)CH₂C(O)CH₃ and —CH═CR₁₀CO₂(C₁-C₃)alkyl where R₁₀ is H or CH₃.

In one aspect of the above compound, wherein A⁺ together with R₁, R₂, R₃ and R₄ form a compound selected from the group consisting of an ammonium, imidazolium, guanidinium, pyridinium, pyridazinium, 1,2,4-triazolium, triazine, sulfonium, phosphazenium and phosphonium.

In another embodiment of the above refrigerant composition, the compound is of the formula 2 or 9:

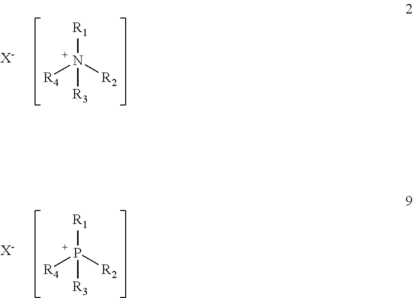

wherein for formula 2, each R₁, R₂, R₃ and R₄ independently form a double bond with N and an adjacent R₁, R₂, R₃ or R₄ group;

wherein for formula 2 and 9, R₁, R₂, R₃ and R₄ are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂;

or for formula 2, wherein R₁, R₂ and R₃ together with N form a heteroaromatic or R₁ and R₂ together with N form a heterocyclic ring each unsubstituted or substituted by a group selected from halo, nitro, trifluoromethyl, trifluoromethoxy, methoxy, carboxy, —NH₂, —OH, —SH, —NHCH₃, —N(CH₃)₂, —SMe, cyano, (C₁-C₃)alkyl, aryl, (C₃-C₆)cycloalkyl, aryl(C₁-C₃)alkyl and heteroaryl; or
wherein at least one of R₁, R₂, R₃ and R₄ is selected from the group consisting of (C₁-C₁₀)alkyl substituted with one —Cl, —Br, —I, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —OC(O)CH₂C(O)CH₃ and —CH═CR₁₀CO₂(C₁-C₃)alkyl where R₁₀ is H or CH₃; and

X⁻ is selected from the group consisting of [PF₆]⁻, [NTf₂]⁻, [BR₅R₆R₇R₈]⁻, [BF₄]⁻, OH⁻, SCN⁻, SbF₆⁻, R₉PO₄⁻, R₉SO₂⁻, R₉SO₃⁻, R₉SO₄⁻, OTf⁻, tris(trifluoromethylsulfonyl)methide, [N(CN)₂]⁻, [CH₃CO₂]⁻, [CF₃CO₂]⁻, [NO₃]⁻, Br⁻, Cl⁻, I⁻, [Al₂Cl₇]⁻, [AlCl₄]⁻, oxalate, dicarboxylates and tricarboxylate, formate, phosphate and aluminate, wherein R₅, R₆, R₇ and R₈ are each independently selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano, and wherein R₉ is selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano.

In another embodiment, the compound is of the formula 3:

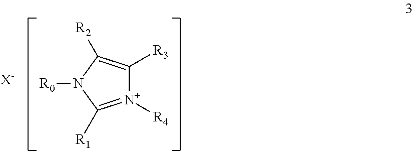

wherein:

Rₒ is selected from the group consisting of (C₁-C₅)alkyl and aryl that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂; and

R₁, R₂, R₃ and R₄ are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂; or

wherein at least one of R₀, R₁, R₂, R₃ and R₄ is selected from the group consisting of (C₁-C₁₀)alkyl substituted with one —Cl, —Br, —I, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —OC(O)CH₂C(O)CH₃ and —CH═CR₁₀CO₂(C₁-C₃)alkyl where R₁₀ is H or CH₃; and

X⁻ is selected from the group consisting of [PF₆]⁻, [NTf₂]⁻, [BR₅R₆R₇R₈]⁻, [BF₄]⁻, OH⁻, SCN⁻, SbF₆⁻, R₉PO₄⁻, R₉SO₂⁻, R₉SO₃⁻, R₉SO₄⁻, OTf⁻, tris(trifluoromethylsulfonyl)methide, [N(CN)₂]⁻, [CH₃CO₂]⁻, [CF₃CO₂]⁻, [NO₃]⁻, Br⁻, Cl⁻, I⁻, [Al₂Cl₇]⁻, [AlCl₄]⁻, oxalate, dicarboxylates and tricarboxylate, formate, phosphate and aluminate, wherein R₅, R₆, R₇ and R₈ are each independently selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano, and wherein R₉ is selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano.

In another embodiment of the above, the compound is of the formula 4:

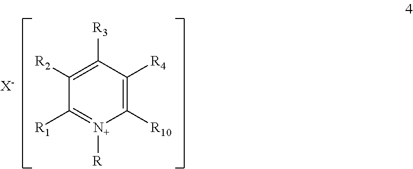

wherein R₁, R₂, R₃, R₄ and R₁₀ are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂;

R is selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂; or
wherein at least one of R, R₁, R₂, R₃, R₄ and R₁₀ is selected from the group consisting of (C₁-C₁₀)alkyl substituted with one —Cl, —Br, —I, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —OC(O)CH₂C(O)CH₃ and —CH═CR₁₀CO₂(C₁-C₃)alkyl where R₁₀ is H or CH₃; and

X⁻ is selected from the group consisting of [PF₆]⁻, [NTf₂]⁻, [BR₅R₆R₇R₈]⁻, [BF₄]⁻, OH⁻, SCN⁻, SbF₆⁻, R₉PO₄⁻, R₉SO₂⁻, R₉SO₃⁻, R₉SO₄⁻, OTf⁻, tris(trifluoromethylsulfonyl)methide, [N(CN)₂]⁻, [CH₃CO₂]⁻, [CF₃CO₂]⁻, [NO₃], Br⁻, Cl⁻, I⁻, [Al₂Cl₇]⁻, [AlCl₄]⁻, oxalate, dicarboxylates and tricarboxylate, formate, phosphate and aluminate, wherein R₅, R₆, R₇ and R₈ are each independently selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano, and wherein R₉ is selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano.

In another embodiment of the refrigerant composition of the above, the compound is of the formula 5 or 6:

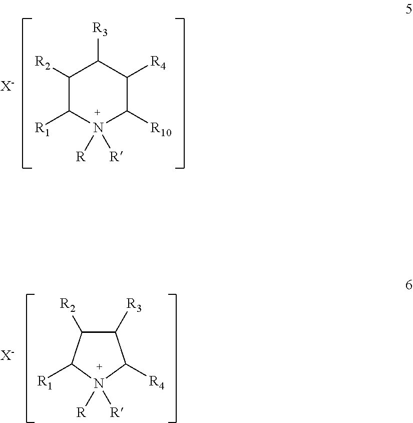

wherein R₁, R₂, R₃, R₄ and R₁₀ are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂; or wherein at least one of R, R₁, R₂, R₃, R₄ and R₁₀ is selected from the group consisting of (C₁-C₁₀)alkyl substituted with one —Cl, —Br, —I, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —OC(O)CH₂C(O)CH₃ and —CH═CR₁₀CO₂(C₁-C₃)alkyl where R₁₀ is H or CH₃; and

R and R′ are independently selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂; and

X⁻ is selected from the group consisting of [PF₆]⁻, [NTf₂]⁻, [BR₅R₆R₇R₈]⁻, [BF₄]⁻, Off, SCN⁻, SbF₆⁻, R₉PO₄⁻, R₉SO₂⁻, R₉SO₃⁻, R₉SO₄⁻, OTf⁻, tris(trifluoromethylsulfonyl)methide, [N(CN)₂]⁻, [CH₃CO₂]⁻, [CF₃CO₂]⁻, [NO₃]⁻, Br⁻, Cl⁻, I⁻, [Al₂Cl₇]⁻, [AlCl₄]⁻, oxalate, dicarboxylates and tricarboxylate, formate, phosphate and aluminate, wherein R₅, R₆, R₇ and R₈ are each independently selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano, and wherein R₉ is selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano.

In another embodiment of the refrigerant composition, the compound is of the formula 7 or 8:

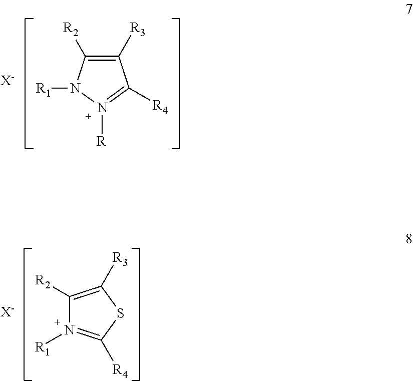

wherein:

R is selected from the group consisting of (C₁-C₅)alkyl and aryl that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂; and

R₁, R₂, R₃ and R₄ are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂; or wherein at least one of R, R₁, R₂, R₃ and R₄ is selected from the group consisting of (C₁-C₁₀)alkyl substituted with one —Cl, —Br, —I, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —OC(O)CH₂C(O)CH₃ and —CH═CR₁₀CO₂(C₁-C₃)alkyl where R₁₀ is H or CH₃; and

X⁻ is selected from the group consisting of [PF₆]⁻, [NTf₂]⁻, [BR₅R₆R₇R₈]⁻, [BF₄]⁻, OH⁻, SCN⁻, SbF₆⁻, R₉PO₄⁻, R₉SO₂⁻, R₉SO₃⁻, R₉SO₄⁻, OTf⁻, tris(trifluoromethylsulfonyl)methide, [N(CN)₂]⁻, [CH₃CO₂]⁻, [CF₃CO₂]⁻, [NO₃], Br⁻, Cl⁻, I⁻, [Al₂Cl₇]⁻, [AlCl₄]⁻, oxalate, dicarboxylates and tricarboxylate, formate, phosphate and aluminate, wherein R₅, R₆, R₇ and R₈ are each independently selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano, and wherein R₉ is selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano.

In another embodiment of the above refrigerant composition, the compound is of the formula 10:

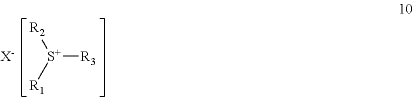

wherein R₁, R₂ and R₃ or are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂; and

X⁻ is selected from the group consisting of [PF₆]⁻, [NTf₂]⁻, [BR₅R₆R₇R₈]⁻, [BF₄]⁻, OH⁻, SCN⁻, SbF₆⁻, R₉PO₄⁻, R₉SO₂⁻, R₉SO₃⁻, R₉SO₄⁻, OTf⁻, tris(trifluoromethylsulfonyl)methide, [N(CN)₂]⁻, [CH₃CO₂]⁻, [CF₃CO₂]⁻, [NO₃]⁻, Br⁻, Cl⁻, I⁻, [Al₂Cl₇]⁻, [AlCl₄]⁻, oxalate, dicarboxylates and tricarboxylate, formate, phosphate and aluminate, wherein R₅, R₆, R₇ and R₈ are each independently selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano, and wherein R₉ is selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano.

In one aspect of the above compound of formula 10, at least one of R₁, R₂, R₃ and R₄ is selected from the group consisting of (C₁-C₁₀)alkyl substituted with one —Cl, —Br, —I, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —OC(O)CH₂C(O)CH₃ and —CH═CR₁₀CO₂(C₁-C₃)alkyl where R₁₀ is H or CH₃;

In another embodiment, there is provided a refrigerant composition for a refrigeration system comprising an IL compound of the formula 11:

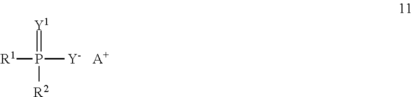

wherein:

Y and Y¹ are each independently selected from O or S;

R¹ and R² are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two halo, —NO₂, CF₃⁻, CF₃O—, CH₃O—, —CO₂H, —NH₂, —OH, —SH, —NHCH₃, —N(CH₃)₂, —CN, —SMe, —SO₃H, —CH═CH₂, —CH₂CH═CH₂, —P((C₁-C₅)alkyl)₂ and —P(O)(OEt)₂, or mixtures of the substituents; and

A⁺ is a cation selected from the group consisting of an ammonium, imidazolium, guanidinium, pyridinium, pyridazinium, 1,2,4-triazolium, triazine, sulfonium, phosphazenium and phosphonium cation.

In one aspect of the above compound, A⁺ is an ammonium cation of the formula 12:

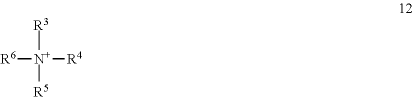

wherein R³, R⁴, R⁵ and R⁶ are each independently a bond or are selected from the group consisting of hydrogen, CF₃, —C₂F₅, —C₃F₇, —C₄F₉, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two Cl, —Br, —I, —NO₂, CF₃O—, CH₃O—, —CO₂H, —NH₂, —OH, —SH, —NHCH₃, —N(CH₃)₂, —CN, —SMe, —SO₃H, CF₃, —C₂F₅, —C₃F₇, —C₄F₉, CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —P((C₁-C₅)alkyl)₂, —P(O)(OEt)₂, —OC(O)CH₂C(O)CH₃ and —CH═CR₁₀CO₂(C₁-C₃)alkyl, where R₁₀ is H or CH₃, or mixtures of the two substituents.

In one embodiment, the gas refrigerant may be selected from an acidic gas and a basic gas. In another embodiment, the gas is selected from a group consisting of ammonia and CO₂. In another embodiment, the basic gas refrigerant may be selected from a group consisting of methylamine, ethylamine and ammonia; or any combination thereof. In another embodiment, the acidic gas refrigerant may be selected from a group consisting of carbon dioxide, nitrous dioxide and sulfur dioxide; or any combination thereof. In yet another embodiment, the gas refrigerant comprises ammonia and carbon dioxide.

In one aspect as disclosed herein, the IL comprises a cation, wherein the cation may be selected from a group consisting of cations of ammonium, imidazolium, pyridinium, phosphonium and sulfonium; or any combination thereof.

In another aspect, the IL comprises an anion, wherein the anion may be selected from a group consisting of the anions of Table 1; or any combination thereof.

In one aspect of the method for using the IL in a refrigeration system, at the compression step, pressurized NH₃ and CO₂ will absorb into the ILs and react to form Zwitterionic ammonium carbamate, which will dissolve in the ILs and further drives the absorption and reaction. In another aspect, the phase change of the gas refrigerants may rely on both the mechanical work input from the compressor and the chemical reaction between the gas refrigerants in the ILs.

In one aspect, the energy consumption using the refrigerant composition may be lower than that of a conventional compression refrigeration system. In another aspect, since ammonium carbamate can decompose at room temperature under reduced pressure, at the evaporation step, the gases are vaporized from the ILs, and may draw more heat from environment than traditional systems: heat of evaporation and heat from the endothermic reverse reaction. In another aspect, the composition for the refrigeration system as disclosed herein may provide more energy efficiency compared to traditional compression refrigeration systems. The Coefficient of Performance (“COP”), defined as the ratio of the heat removed from the cold reservoir to input work, will be higher than that of traditional vapor compression refrigeration systems. In one aspect of the present application, the composition for the refrigeration system may provide a COP greater than 6.9. In one embodiment, the COP may be about 33% more efficient than traditional refrigeration system that employs ammonia as the single gas refrigerant. In another aspect, the COP is about 5% more efficient, 10% more efficient, 20% more efficient, 25% more efficient or about 30% more efficient than traditional refrigeration systems using ammonia as the single refrigeration gas.

The composition disclosed herein may be applied in commercial refrigeration as well as applications in residential refrigeration system. In one aspect of the present application, the composition may provide a primary energy savings of about 525 TBTUs. In one aspect, the composition may provide a primary energy savings of about 100 TBTUs, 200 TBTUs, 300 TBTUs, 400 TBTUs or about 500 TBTUs.

The composition for a refrigeration system disclosed in the present application, which can be used in either compression refrigeration or absorption refrigeration system, may maximize entropy change through phase change or through a multispecies refrigerant reaction.

### DETAILED DESCRIPTION OF THE INVENTION

In one aspect of the present application, there is provided a composition for a refrigeration system, wherein the composition comprises ammonia and CO₂ as dual gas refrigerants; and a liquid working fluid, which may comprise of water, alcohols or ionic liquids, or mixtures thereof.

ILs have been used as organic green solvent in catalysis, separation process, electrochemistry, and many other industries for their unique physical and chemical properties, such as negligible vapor pressure, negligible flammability and thermal stability, low melting temperature and liquid state over a wide temperature range, and good solubility.

In one aspect of the present application, the composition for a refrigeration system comprises multiple suitable refrigerant compositions that are capable of undergoing reversible reactions during the refrigeration cycle. In one embodiment, the composition comprises a suitable liquid working fluid wherein the fluid is selected to aid in both the phase change and the reaction of the refrigerant in the liquid phase. In one embodiment, the fluid may have high solubility for each of the gas refrigerant utilized. In another embodiment, the refrigerant composition comprises a gas refrigerant, wherein the gas refrigerant can dissolve into the fluid and further react to form a product(s) that is soluble in the fluid. In another embodiment, the composition comprises two gas refrigerants. The affinity of the gas refrigerants to dissolve into the fluid reduces the mechanical work required to attain the phase change and aid in achieving the change in entropy more easily. A further reduction in entropy is also attained through the reduction of the number of the gas refrigerant molecules in the fluid. Essentially, more gas is dissolved into fluids at lower pressure, leading to a reduction in energy consumption. When the gases are vaporized from the fluids in the evaporator more heat is drawn from the environment as compared to a conventional refrigeration system.

In one aspect of the present application, the composition may comprise two refrigerant gases. In one embodiment, one gas may be a basic gas and the other may be an acidic gas. In one embodiment, the basic gas refrigerant may be selected from a group consisting of methylamine, ethylamine and ammonia; or any combination thereof. As used herein, a combination also means a mixture of any 2, 3, 4 or more gas refrigerants or ILs. In one embodiment, the acidic gas refrigerant may be selected from a group consisting of carbon dioxide, nitrous dioxide and sulfur dioxide; or any combination thereof. In one aspect, the IL comprises a cation, wherein the cation may be selected from a group consisting of cations of ammonium, imidazolium, pyridinium, phosphonium and sulfonium; or any combination thereof. In another aspect, the IL comprises an anion, wherein the anion may be selected from a group consisting of the anions of Table 1; or any combination thereof.

Reversible reaction between ammonia and CO₂:

2NH₃+CO₂→H₂NCOONH₄

In one aspect of the present application, ammonia and CO₂ can reversibly react to form ammonium carbonate, (NH₄)₂CO₃, which can be employed in the composition. Since ammonium carbonate readily degrades to gaseous ammonia and carbon dioxide upon heating, both gases may be used as gas refrigerants in a refrigeration system. In various aspects of the application, ammonia and CO₂ can react to form either ammonium carbamate or ammonium carbonate, depending on the selection of the working fluid such as water, or non-water such as alcohol or ILs with an OH group; and either or both can be used herein.

In one embodiment, Table 1 provides some common cations and anions.

TABLE 1
Common Cations:

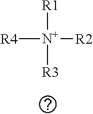

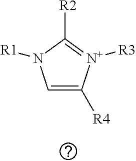

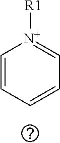

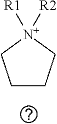

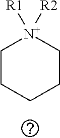

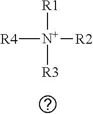

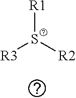

Common Anions:
BF [symbol] , B(CN) [symbol] , CH [symbol] BF [symbol] , CH [symbol] CHBF [symbol] , CF [symbol] BF [symbol] ,
C [symbol] F [symbol] BF [symbol] , n-C [symbol] F [symbol] BF [symbol] , nC [symbol] F [symbol] BF [symbol] , PF [symbol] ,
CF [symbol] CO [symbol] , CF [symbol] SO [symbol] , N(SO [symbol] CF [symbol] ) [symbol] ,
N(COCF [symbol] )(SO [symbol] CF [symbol] ), N(SO [symbol] F) [symbol] ,N(CN) [symbol] , C(CN) [symbol] ,
SCN, SeCN, CuCl [symbol] , AlCl [symbol] , F(HF) [symbol] , etc. [symbol]
indicates data missing or illegible when filed

In one aspect of the present application, the refrigerant composition comprising dual gas refrigerants disclosed herein may be used in a refrigeration system, wherein the refrigeration system can be either a compression system or an absorption system. In various embodiments, certain example disclosed herein employs a compression cycle, but both compression and absorption may be similarly improved through the use of the composition comprising ionic fluids as disclosed herein.

In one aspect, the present application discloses phosphinate ILs that may be used as working fluids in a refrigeration system, providing advantages over the traditional working fluids. In another aspect, the present application discloses a more efficient refrigeration system that incorporates good solubility towards ammonia carbonate or ammonium carbamate, environmentally benign, stable and non-toxic.

In one aspect, the composition may comprise suitable additives that may be useful in lowering the viscosity of the composition; or lowering of the melting point of the composition. As a consequence of using the additives, the system provides a lower operating cost. In another aspect, the composition may comprise suitable additives such as corrosion inhibitors, antifoaming agents and antioxidants, or mixtures thereof. These suitable additives may be added in particular proportion which is well known to a skilled person familiar with refrigeration system.

In one aspect of the present application, the composition may be employed in a compression system. In one embodiment, the composition comprises an IL and a dual gas refrigerant. In one embodiment, the gas refrigerant is selected from ammonia and carbon dioxide.

Additionally, incorporating biodegradable groups can make ILs ready biodegradable and completely non-toxic.

In one embodiment, there is provided a refrigerant composition for a refrigeration system comprising an IL compound of the formula 1:

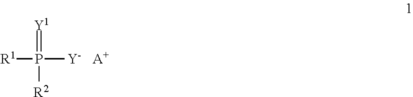

wherein:

Y and Y¹ are each independently selected from O or S;

R¹ and R² are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two halo, —NO₂, CF₃—, CF₃O—, CH₃O—, —CO₂H, —NH₂, —OH, —SH, —NHCH₃, —N(CH₃)₂, —CN, —SMe, —SO₃H, —CH═CH₂, —CH₂CH═CH₂, —P((C₁-C₅)alkyl)₂ and —P(O)(OEt)₂, or mixtures of the substituents; and

A⁺ is a cation selected from the group consisting of an ammonium, imidazolium, guanidinium, pyridinium, pyridazinium, 1,2,4-triazolium, triazine, sulfonium, phosphazenium and phosphonium cation. In one variation, Y and Y¹ are both O.

In one aspect of the above, the IL do not include a combination or a mixture of zinc and aluminum phosphinates. In one aspect of the above, the phosphinate IL is selected from trihexyltetradecylphosphonium bis(2,4,-trimethylpentyl)phosphinate and trihexyl(tetradecyl)phosphonium bis-2,4,4-(trimethylpentyl)phosphinate. In another aspect, A⁺ is a metal such that the IL compound is of the formula (R¹R²P(═O)O⁻)₁Mⁿ⁺ wherein M is a metal and n corresponds to the charge of the metal. In one aspect, M is an alkali metal selected from lithium, sodium, potassium and cesium. In another aspect of the above, the IL does not contain any halide or is halide free.

In one aspect of the above compound, A⁺ is an ammonium cation of the formula 2:

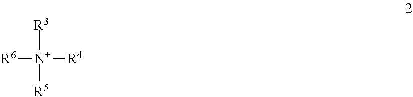

wherein R³, R⁴, R⁵ and R⁶ are each independently a bond or are selected from the group consisting of hydrogen, CF₃, —C₂F₅, —C₃F₇, —C₄F₉, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two —Cl, —Br, —I, —NO₂, CF₃O—, CH₃O—, —CO₂H, —NH₂, —OH, —SH, —NHCH₃, —N(CH₃)₂, —CN, —SMe, —SO₃H, —CF₃, —C₂F, —C₃F₇, —C₄F₉, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —P((C₁-C₅)alkyl)₂, —P(O)(OEt)₂, —OC(O)CH₂C(O)CH₃ and —CH═CR₁₀CO₂(C₁-C₃)alkyl, where R₁₀ is H or CH₃, or mixtures of the two substituents.

In another aspect of the above, N⁺ together with R³, R⁴, R⁵ and R⁶ form a cation selected from the group consisting of ammonium, imidazolium, guanidinium, pyridinium, pyridazinium and 1,2,4-triazolium, each of which is unsubstituted or substituted by one or two substituents selected from the group consisting of —Cl, —Br, —I, —NO₂, CF₃O—, CH₃O—, —CO₂H, —NH₂, —OH, —SH, —NHCH₃, —N(CH₃)₂, —CN, —SMe, —SO₃H, —CF₃, —C₂F, —C₃F₇, —C₄F₉, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —P((C₁-C₅)alkyl)₂, —P(O)(OEt)₂, —OC(O)CH₂C(O)CH₃ and —CH═CR₁₀CO₂(C₁-C₃)alkyl, where R₁₀ is H or CH₃, or mixtures of the two substituents.

As defined herein, the clause “N⁺ together with R³, R⁴, R⁵ and R⁶ form a cation selected from the group consisting of ammonium, imidazolium, guanidinium, pyridinium, pyridazinium and 1,2,4-triazolium” means that in certain embodiments where the cation is an acyclic or cyclic cation, one of R³, R⁴, R⁵ and R⁶ together with another R group (i.e., R³, R⁴, R⁵ and R⁶) on N⁺ may form a double bond.

In one aspect of the ammonium compound of the formula 2, the compound is selected from the group consisting of imidazolium, 1H-pyrazolium, 3H-pyrazolium, 4H-pyrazolium, 1-pyrazolinium, 2-pyrazolinium, 3-pyrazolinium, 2,3-dihydroimidazolinium, 4,5-dihydroimidazolinium, 2,5-dihydroimidazolinium, pyrrolidinium, 1,2,4-triazolium, 1,2,3-triazolium, pyridinium, pyridazinium, pyrimidinium, piperidinium, morpholinium, pyrazinium, thiazolium, oxazolium, indolium, quinolinium, isoquinolinium, quinoxalinium and indolinium.

In another aspect of the above, the compound of the formula 2 is selected from the group consisting of:

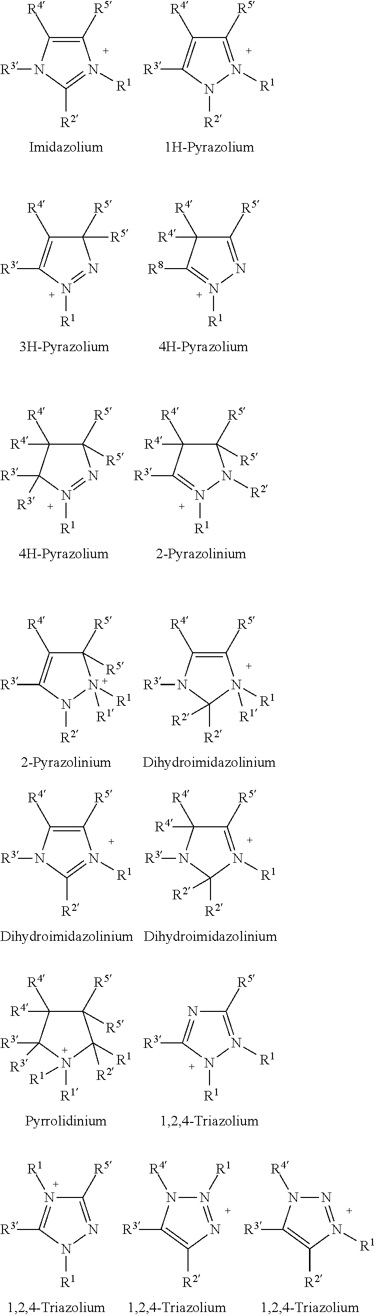

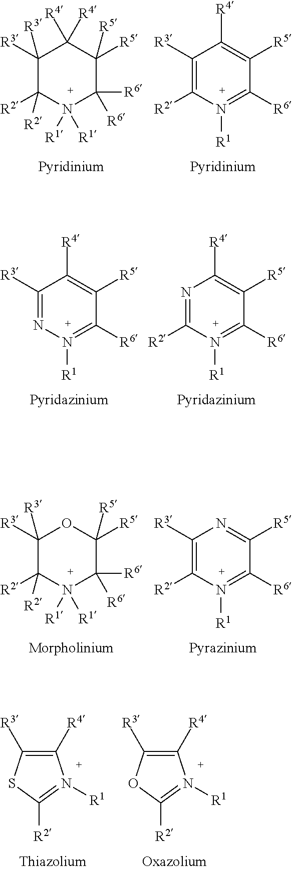

wherein:

each R¹, R^{1′}, R², R³, R^{3′}, R⁴, R⁵, R^{5′}, R⁶ and R^{6′} is independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two halo, —NO₂, CF₃—, CF₃O—, CH₃O—, —CO₂H, —NH₂, —OH, —SH, —NHCH₃, —N(CH₃)₂, —CN, —SMe, —SO₃H, —CH═CH₂, —CH₂CH═CH₂, —P((C₁-C₅)alkyl)₂ and —P(O)(OEt)₂, or mixtures of the two substituents.

In one aspect of the above, each R¹, R^{1′}, R², R^{2′}, R³, R^{3′}, R⁴, R^{4′}, R⁵, R^{5′}, R⁶ and R^{6′} is independently selected from the group consisting of hydrogen, (C₁-C₁₀)alkyl and aryl(C₁-C₈)alkyl group, each of which may be unsubstituted or substituted with one or two halo, —NO₂, CF₃—, CF₃O—, CH₃O—, —CO₂H, —NH₂, —OH, —SH, —NHCH₃, —N(CH₃)₂, —CN, —SMe, —SO₃H, —CH═CH₂, —CH₂CH═CH₂, —P((C₁-C₅)alkyl)₂ and —P(O)(OEt)₂, or mixtures of the two substituents. In another aspect of the above, each R¹, R^{1′}, R², R^{2′}, R³, R^{3′}, R⁴, R^{4′}, R⁵, R^{5′}, R⁶ and R^{6′} is independently selected from the group consisting of hydrogen, —CH₃, —CF₃, —C₂F₅, —C₃F₇, —C₄F₉, unsubstituted (C₂-C₁₀)alkyl, —CH₂phenyl and (C₁-C₁₀)alkyl substituted with one —Cl, —Br, —I, —CF₃, —C₂F₅, —C₃F₇, —C₄F₉, —CH═CH, —CH₂CH═CH, —CH₂CHCH, -ethylene oxide, —OC(O)—CH═CH, —NCO, —C(O)Cl, —C(O)Br, —C(O)-imidazolyl and —CO₂(C₁-C₃)alkyl.

In another aspect of the above, the compound is of the formula 1a:

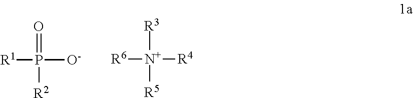

wherein:

R¹ and R² are each independently selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two halo, —NO₂, CF₃—, CF₃O—, CH₃O—, —CO₂H, —NH₂, —OH, —SH, —NHCH₃, —N(CH₃)₂, —CN, —SMe, —SO₃H, —CH═CH₂, —CH₂CH═CH₂, —P((C₁-C₅)alkyl)₂ and —P(O)(OEt)₂, or mixtures of the substituents; and

wherein R³, R⁴, R⁵ and R⁶ are each independently a bond or are selected from the group consisting of hydrogen, —CF₃, —C₂F₅, —C₃F₇, —C₄F₉, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two —Cl, —Br, —I, —NO₂, CF₃O—, CH₃O—, —CO₂H, —NH₂, —OH, —SH, —NHCH₃, —N(CH₃)₂, —CN, —SMe, —SO₃H, —CF₃, —C₂F₅, —C₃F₇, —C₄F₉, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —P(C₁-C₅)alkyl)₂, —P(O)(OEt)₂, —OC(O)CH₂C(O)CH₃ and —CH═CR₁₀CO₂(C₁-C₃)alkyl, where R₁₀ is H or CH₃, or mixtures of the two substituents; or wherein N⁺ together with R³, R⁴, R⁵ and R⁶ form a cation selected from the group consisting of ammonium, imidazolium, guanidinium, pyridinium, pyridazinium and 1,2,4-triazolium, each of which is unsubstituted or substituted by one or two substituents selected from the group consisting of —Cl, —Br, —I, —NO₂, CF₃O—, CH₃O—, —CO₂H, —NH₂, —OH, —SH, —NHCH₃, —N(CH₃)₂, —CN, —SMe, —SO₃H, —CF₃, —C₂F₅, —C₃F₇, —C₄F₉, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —P((C₁-C₅)alkyl)₂, —P(O)(OEt)₂, —OC(O)CH₂C(O)CH₃ and —CH═CR₁₀CO₂(C₁-C₃)alkyl, where R₁₀ is H or CH₃, or mixtures of the two substituents.

In yet another aspect of the above, the compound is of the formula 1a, wherein at least one of R₁, R₂, R₃, R₄, R₅ or R₆ is selected from the group consisting of CF₃, —C₂F₅, —C₃F₇, —C₄F₉, unsubstituted (C₁-C₁₀)alkyl, and (C₁-C₁₀)alkyl substituted with one Cl, —Br, —I, CF₃, —C₂F₅, —C₃F₇, —C₄F₉, CH═CH, —CH₂CH═CH, —CH₂CHCH, -ethylene oxide, —OC(O)—CH═CH, —NCO, —C(O)Cl, —C(O)Br, —C(O)-imidazolyl, —CO₂(C₁-C₃)alkyl, —OC(O)CH₂C(O)CH₃ and —CH═CR₁₀CO₂(C₁-C₃)alkyl, where R₁₀ is H or CH₃. In yet another aspect of the method, the compound is of the formula:

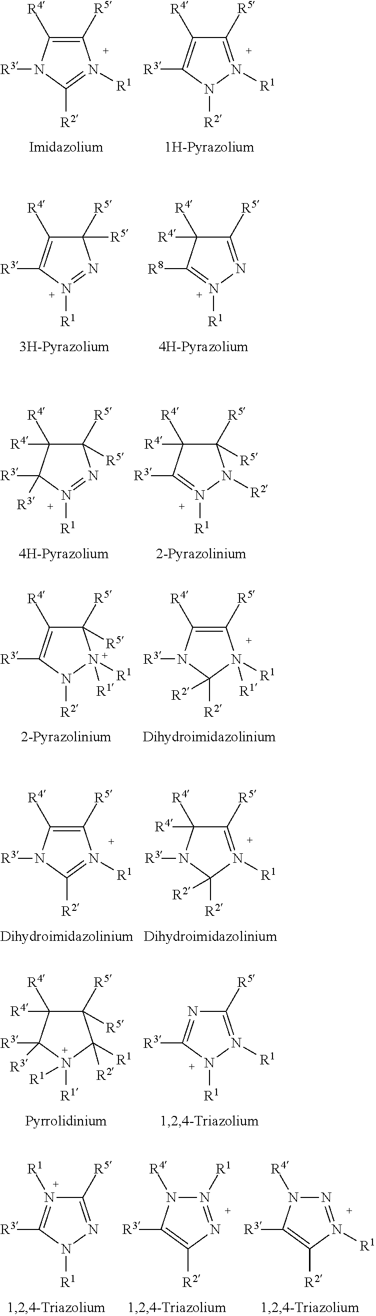

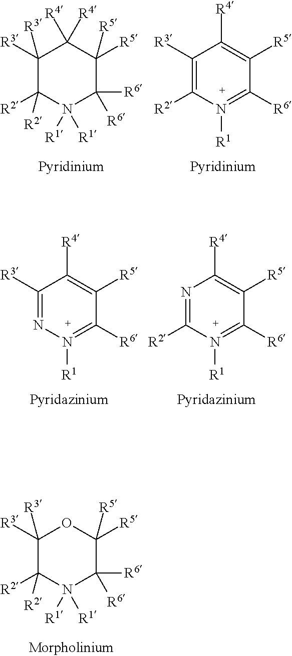

In one variation, the refrigerant composition further comprises a second, different IL. As disclosed herein, the second, different IL may be one of the ILs disclosed herein.

In one embodiment, the ILs of the present application are further modified by the incorporation with ethereal side chains to provide biodegradable and nontoxic ILs. See, for example, Greener Solvents; Room Temperature ILs from Biorenewable Sources, Scott Handy, Chem. Eur. J. 2003, 9, 2938-2944.

In one embodiment of the present application, the refrigerant composition is used in a single evaporator refrigeration system. In another embodiment, the composition is used in a dual evaporator refrigeration system. In a dual evaporator refrigeration system, each evaporator may be used to separately cool different areas or compartments of a cooling system, such as the freezer and fresh food compartment of a refrigerator. Such refrigeration system may be employed in mobile transport systems such as in cars, motorcycles, boats, trucks, trains and airplanes.

In one aspect of the present application, there is provided are refrigerant composition for a refrigeration system comprising ILs. In one embodiment, the refrigeration system may be used in household or commercial application. In other embodiments, the composition disclosed in the present application may be applied to any other suitable environments in which it would be desirable to improve energy efficiency in the case of a refrigeration system.

It is to be appreciated that one ordinarily skilled in the art will realize that well-known heat exchange and heat transfer principles may be applied to determine appropriate dimensions and materials of the various assemblies illustratively described herein, as well as flow rates of refrigerant that may be appropriate for various applications and operating conditions.

Furthermore, vapor compression and absorption refrigeration cycles are already well-known methods of cooling and are described by Haaf, S. and Henrici, H. in “Refrigeration Technology” (Ullmann's Encyclopedia of Industrial Chemistry, 6th Ed., Wiley Verlag). The basic cooling cycle is the same for the absorption and vapor compression systems. Both systems use a low-temperature liquid refrigerant that absorbs heat from water, air or any medium to be cooled, and converts to a vapor phase (in the evaporator section). The refrigerant vapors are then compressed to a higher pressure (by a compressor or a generator), converted back into a liquid by rejecting heat to the external surroundings (in the condenser section), and then expanded to a low-pressure mixture of liquid and vapor (in the expander section) that goes back to the evaporator section and the cycle is repeated.

Ammonium carbamate is an unstable compound derived from ammonia and carbon dioxide. It may decompose rapidly and completely at room temperature under reduced pressure, which makes the reaction suitable to be used in a refrigeration system. In one embodiment, one or more ILs may be used as working fluids to solubilize the Zwitterionic reaction product.

In another embodiment, the reduction in energy consumption and the resulting carbon emissions may be from about 10% to about 70%, from about 15% to about 60%, from about 20% to about 50%, or from about 30% to about 40%. In one embodiment, the reduction in energy consumption and the resulting carbon emissions may be 5%, 10%, 15%, 20%, 30%, 50%, 60% or 70%.

In another aspect of the present application, the ratio of ammonia to CO₂ (ammonia:CO₂) or the ratio of CO₂ to ammonia (CO₂:ammonia) may be 1:99, 2:98, 5:95, 10:90, 15:85, 20:80, 25:75, 30:70, 35:65, 40:60, or 50:50.

In one aspect, the starting volume of the IL and the gas refrigerant may depend upon the specific component of the specific refrigeration system being used. In one embodiment, the refrigeration system may be a vapor absorption system or a vapor compression system.

In one aspect of the present application, a lower pressure may be present in the refrigeration system, which may significantly reduce the ammonia leakage problem. Additionally, the charging of ammonia may be reduced by the addition of CO₂ and the use of ILs. In one embodiment, any ammonia that may be leaked may be diluted by the CO₂. In one aspect, the system can be made sufficiently safe, practical and cost-effective for home use.

In another aspect of the present application, the composition for the refrigeration system may be used for district cooling in a metropolitan area. District cooling uses a central plant to cool an entire city block.

In one aspect, the composition for the refrigeration system may comprise ILs, or ILs and another working fluid. In one embodiment, the working fluid may be selected from a group consisting of water, an alcohol or mixtures of alcohols, ILs with an OH group; or any combination thereof.

In one embodiment, the composition for the refrigeration system may comprise ILs and water. In another embodiment, the composition may comprise ILs and one or more alcohols.

In one aspect of the present application, there is provided a refrigeration system comprising a refrigerant composition and an apparatus, wherein the refrigerant composition comprises a gas refrigerant and a working fluid, which may be a liquid, wherein the apparatus comprises: (a) an absorption/reaction chamber configured to receive the gas refrigerant that is passed from a compressor into the absorption/reaction chamber; (b) an evaporator/desorber chamber configured to pass an unsaturated working fluid to the absorption/reaction chamber; wherein the gas refrigerant and the unsaturated working fluid reversibly react in the absorption/reaction chamber under high pressure to form a saturated working fluid; (c) a hot side heat exchanger configured to be connected to the absorption/reaction chamber; (d) a pressure reduction device configured to receive the saturated working fluid from the absorption/reaction chamber and to pass the saturated working fluid to the evaporator/desorption chamber; wherein the gas refrigerant vaporizes from the saturated working fluid under low pressure in the evaporator/desorption chamber to form the unsaturated working fluid; (e) a cold side heat exchanger configured to be connected to the evaporator/desorption chamber; and (f) a conduit configured to receive the gas refrigerant from the evaporator/desorption chamber and to return the gas refrigerant to the compressor. In one aspect of the above, the working fluid is selected from the group consisting of an alcohol, water and an ionic liquid, or mixtures thereof.

In one aspect of the present application, there is provided a refrigeration system comprising a refrigerant composition and an apparatus, wherein the refrigerant composition comprises a gas refrigerant and an ionic liquid, wherein the apparatus comprises:

(a) an absorption/reaction chamber configured to receive the gas refrigerant that is passed from a compressor into the absorption/reaction chamber;

(b) an evaporator/desorber chamber configured to pass an unsaturated ionic liquid to the absorption/reaction chamber;

wherein the gas refrigerant and the unsaturated ionic liquid reversibly react in the absorption/reaction chamber under high pressure to form a saturated ionic liquid;

(c) a hot side heat exchanger configured to be connected to the absorption/reaction chamber;

(d) a pressure reduction device configured to receive the saturated ionic liquid from the absorption/reaction chamber and to pass the saturated ionic liquid to the evaporator/desorption chamber;

wherein the gas refrigerant vaporizes from the saturated ionic liquid under low pressure in the evaporator/desorption chamber to form the unsaturated ionic liquid;

(e) a cold side heat exchanger configured to be connected to the evaporator/desorption chamber; and

(f) a conduit configured to receive the gas refrigerant from the evaporator/desorption chamber and to return the gas refrigerant to the compressor.

In one embodiment of the refrigeration systems and apparatus disclosed herein, the refrigerant composition for the refrigeration system is the composition according to any one of the formulas disclosed in the present application.

In another embodiment, the conduit comprises a device that is configured to pass the ionic liquid refrigerant to the absorption/reaction chamber. In one embodiment, the ionic liquid is unsaturated. In one embodiment, the pressure reduction device may be a pressure drop valve, expansion valve or other flow control devices. In another embodiment, the pressure reduction device may be controlled by a pressure level sensor.

In another embodiment, the evaporator/desorber chamber may be configured to pass the unsaturated ionic liquid to the absorption/reaction chamber via a conduit such as a tube or a coil. In one embodiment, the hot side heat exchanger is configured to return the saturated ionic liquid to the absorption/reaction chamber via a sprayer. In one embodiment, the hot side heat exchanger comprises a recirculating pump or heat exchange pump. In one embodiment, the cold side heat exchange pump comprises a recirculation pump or a heat exchange pump.

In another embodiment of the present application, there is provided an apparatus for a refrigeration system comprising: 1) a compressor; 2) a condenser; 3) a pressure reduction device; 4) an evaporator; and 5) a conduit that returns refrigerant vapor to the compressor; and a refrigerant composition for the refrigeration system; wherein the refrigerant composition for the refrigeration system is the composition as disclosed herein.

In one aspect of the present application, there is provided an apparatus for adjusting temperature that executes an absorption cycle as described herein to cool or heat an object or space. In one embodiment, the apparatus may comprise components such as an absorber/reaction chamber, a desorber/evaporator chamber, a compressor, cold side and hot side heat exchangers, a pressure control device and a pump for circulating the refrigeration composition. In one embodiment, the apparatus may comprise condenser and evaporator units with an expansion valve similar to equipment used in an ordinary vapor compression cycle. In another embodiment, the apparatus may be capable of executing an absorption refrigeration cycle using any one or more of the refrigeration composition as disclosed herein.

In one embodiment, the compressor may operate as an oil-free compressor. In another embodiment, the compressor may operate with a mixture of oil and ILs.

In one aspect, when a compressor is used to mechanically increase the pressure of a gas refrigerant, a suitable lubricant, for example an oil, is used in the compressor to lubricate the compressor bearings and other moving parts. Often the oil may leak from the compressor past the piston rings in reciprocating compressors. If the oil level in the compressor becomes critically low, the compressor bearings and other moving parts can overheat and fail.

Many sealed compressors are used for refrigerators, window air-conditioners, residential heat pumps, and commercial air-handlers. These compressors are precharged at the factory with the correct amount of oil, and a drop in oil level can reduce the life expectancy for these machines. Accordingly, in one embodiment of the present application, the compressor comprises moving parts that may be lubricated by an IL. In one aspect, the lubrication system is oil-free.

In one embodiment, the ionic liquid-based lubricant for the compressor may have high solubility for the refrigerant and good friction/wear characteristics.

In another embodiment, the apparatus for a refrigeration system may include oil separating device in the discharge line of the compressor to trap oil and return it to the compressor. In another embodiment, the refrigerant pipes or conduits can also be designed to allow the oil to flow downhill back to the compressor using gravity.

In various embodiments, the compressor may be selected from a group consisting of reciprocating, rotary, screw, centrifugal and scroll compressors. In various embodiments, the compressor may be open, hermetic (sealed), or semi-hermetic.

In one aspect of the present application, there is provided an apparatus for adjusting temperature that executes an absorption cycle as described herein to cool or heat an object or space.

In one embodiment, the apparatus may comprise an absorber-generator circuit, which may replace a traditional compressor, where the circuit may comprise an absorber, a generator, a heat exchanger, a pressure control device and a pump for circulating the refrigeration composition.

In another aspect, the pressure reduction device may be a thermal expansion valve, a capillary tube, or a throttle valve. In one embodiment, the pressure reduction device may be coupled to a sensor which controls the flow of the refrigeration composition into the evaporator or into the desorber. In yet another embodiment, the thermal expansion valve may be internally or externally equalized expansion valve.

A person skilled in the art of constructing and configuring the components of the refrigeration system will be familiar with the various components disclosed herein.

The compositions disclosed in the present application may be prepared by any convenient method, including mixing or combining the desired amounts in an appropriate container, or in a device that executes an absorption refrigeration cycle.

In one embodiment, additives, such as lubricants, corrosion inhibitors, stabilizers, dyes, and other appropriate materials may be added to the compositions for their intended applications, provided they do not result in an adverse effect on the composition, or operation of the system.

In yet another aspect of the present application, the compressor, such as a vapor compressor, may be replaced by a thermochemical process resulted from the absorption of the gas refrigerants into the ILs. Such refrigeration system comprises an absorber, a desorber, a solution heat exchanger, a condenser, an expansion device and an evaporator. In one embodiment, the refrigeration composition may be pressurized by a liquid pump which receives the composition from the absorber. A solution heat exchanger then pre-heats the composition. In the desorber, heated gas refrigerant is vaporized from the composition. In one aspect, the IL is returned to the absorber via the solution heat exchanger and the expansion device.

In one embodiment, the refrigeration system or apparatus may be used in a refrigerator, a freezer, an ice machine, an air conditioner, an industrial cooling system, a heater or heat pump. In another embodiment, the apparatus may be used in a residential, commercial or industrial setting. In another embodiment, the apparatus may be incorporated into a transportation mode such as an automobile, airplane, truck, boat, bus, or train. In one embodiment, the apparatus may be incorporated into an equipment, for example a medical instrument, that require such temperature adjustment. In addition to the exemplary embodiments, aspects and variations described above, further embodiments, aspects and variations will become apparent by reference to the drawings and figures and by examination of the following descriptions.

In one embodiment, the composition according to claim 1 comprises an IL and a gas refrigerant. In one embodiment, the IL is a compound of the formula 1, wherein A⁺ is an ammonium cation of the formula 2:

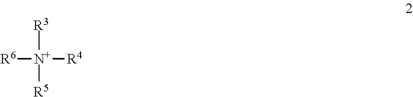

wherein the compound of the formula 2 is selected from the group consisting of:

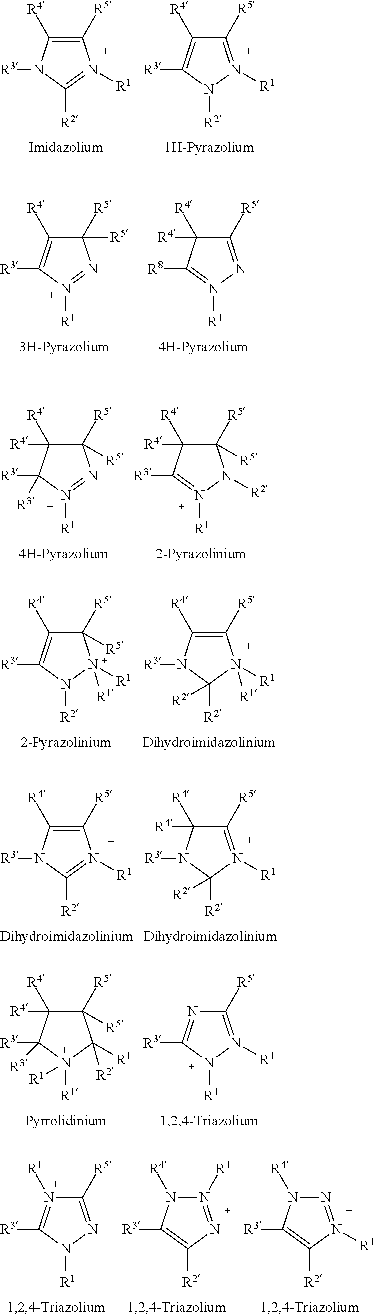

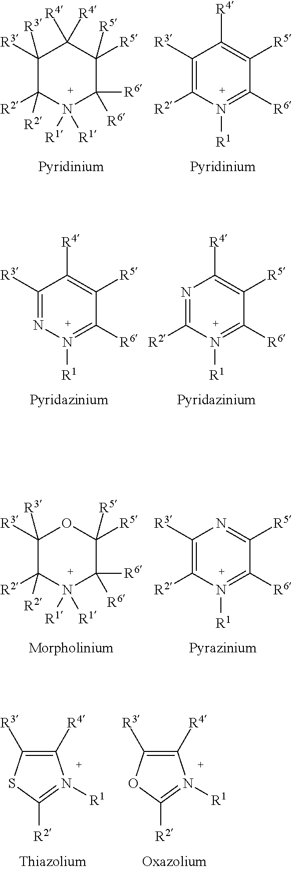

A skilled artisan will realize that the rates, dimensions and materials for the refrigeration system may be determined and selected in accordance with well-known heat exchange and heat transfer principles as described, for example, in R. K. Shah, “Fundamentals of Heat Exchanger Design”, Wiley & Sons, 2003, or F. P. Incropera et al., “Introduction to Heat Transfer”, Wiley & Sons, 2006, the disclosures of which are incorporated by reference herein.

Additionally, temperature adjustment systems, such as absorption cooling-heating system or vapor-compression refrigeration system are also described in U.S. Pat. Nos. 8,568,608, 8,696,928 and 8,707,720. The content of all references disclosed are incorporated by reference herein.

### DEFINITIONS

Unless specifically noted otherwise herein, the definitions of the terms used are standard definitions used in the chemical arts and cooling and refrigeration systems.

Exemplary embodiments, aspects and variations are illustrative in the figures and drawings, and it is intended that the embodiments, aspects and variations, and the figures and drawings disclosed herein are to be considered illustrative and not limiting.

In one variation, the group that is an alkyl, aryl, heterocyclyl, (C₁-C₈)cycloalkyl, hetrocyclyl(C₁-C₈)alkyl, aryl(C₁-C₈)alkyl, heteroaryl or heteroaryl(C₁-C₈)alkyl group may be substituted or unsubstituted.

An “alkyl” group is a straight, branched, saturated or unsaturated, aliphatic group having a chain of carbon atoms, optionally with oxygen, nitrogen or sulfur atoms inserted between the carbon atoms in the chain or as indicated. A (C₁-C₂₀)alkyl, for example, includes alkyl groups that have a chain of between 1 and 20 carbon atoms, and include, for example, the groups methyl, ethyl, propyl, isopropyl, vinyl, allyl, 1-propenyl, isopropenyl, ethynyl, 1-propynyl, 2-propynyl, 1,3-butadienyl, penta-1,3-dienyl, penta-1,4-dienyl, hexa-1,3-dienyl, hexa-1,3,5-trienyl, and the like. An alkyl group may also be represented, for example, as a —(CR¹R²)ₘ— group where R¹ and R² are independently hydrogen or are independently absent, and for example, m is 1 to 8, and such representation is also intended to cover both saturated and unsaturated alkyl groups.

An alkyl as noted with another group such as an aryl group, represented as “arylalkyl” for example, is intended to be a straight, branched, saturated or unsaturated aliphatic divalent group with the number of atoms indicated in the alkyl group (as in (C₁-C₂₀)alkyl, for example) and/or aryl group (as in (C₅-C₁₄)aryl, for example) or when no atoms are indicated means a bond between the aryl and the alkyl group. Nonexclusive examples of such group include benzyl, phenethyl and the like.

An “alkylene” group is a straight, branched, saturated or unsaturated aliphatic divalent group with the number of atoms indicated in the alkyl group; for example, a —(C₁-C₃)alkylene- or —(C₁-C₃)alkylenyl-.

A “cyclyl” such as a monocyclyl or polycyclyl group includes monocyclic, or linearly fused, angularly fused or bridged polycycloalkyl, or combinations thereof. Such cyclyl group is intended to include the heterocyclyl analogs. A cyclyl group may be saturated, partially saturated or aromatic.

“Halogen” or “halo” means fluorine, chlorine, bromine or iodine.

A “heterocyclyl” or “heterocycle” is a mono-cycloalkyl or bi-cycloalkyl wherein one or more of the atoms forming the ring or rings is a heteroatom that is a N, O, or S. Nonexclusive examples of heterocyclyl include piperidyl, 4-morpholyl, 4-piperazinyl, pyrrolidinyl, 1,4-diazaperhydroepinyl, 1,3-dioxanyl, and the like. In one aspect, the heterocyclyl may also include carbohydrate-based compounds, such as glucose. Accordingly, the ILs of the present application includes sugar-derived ILs, including glucose-derived ILs. Such glucose derived ILs include 1,5-anhydro-2,3,4-tri-O-methyl-D-glucitol-6-O-triethylammonium trifluoromethanesulfonate, 1,5-anhydro-2,3,4-tri-O-methyl-D-glucitol-6-O-diethylsulfonium trifluoromethanesulfonate and 1,5-anhydro-2,3,4-tri-O-methyl-D-glucitol-6-O-tetrahydrothiophenyl trifluoromethanesulfonate.

Salts include acid addition salts formed with inorganic acids such as hydrochloric acid, hydrobromic acid, sulfuric acid, phosphoric acid, and the like; or with organic acids such as acetic acid, propionic acid, hexanoic acid, malonic acid, succinic acid, malic acid, citric acid, gluconic acid, salicylic acid and the like.

“Substituted or unsubstituted” or “optionally substituted” means that a group such as, for example, alkyl (such as C₁-C₂₀alkyl), aryl, heterocyclyl, (C₁-C₈)cycloalkyl, hetrocyclyl(C₁-C₈)alkyl, aryl(C₁-C₈)alkyl, heteroaryl, heteroaryl(C₁-C₈)alkyl, and the like, unless specifically noted otherwise, may be unsubstituted or, may substituted by 1, 2 or 3 Substituents selected from the group such as halo, nitro, trifluoromethyl, trifluoromethoxy, methoxy, carboxy, —NH₂, —OH, —SH, —NHCH₃, —N(CH₃)₂, —SMe, cyano and the like.

In one embodiment, the ILs of the present application may be racemic compounds or may be chiral substantially enantiomeric or diastereomeric pure or mixtures thereof.

An ionic liquid is a salt in which the ions are poorly coordinated as is well known in the art. At least one ion in the salt has a delocalized charge and one component is organic, which prevents the formation of a stable crystal lattice.

Ionic liquids (ILs) have capabilities to form a wide range of intermolecular interactions that include strong and weak ionic, hydrogen boding, van der Waals, dispersive, pie-pie interactions. ILs have been intensively studied for many applications, such as solvents, catalysts, separation, extraction, biomass processing, etc.

As used herein, “composition” is used interchangeably with a “refrigerant composition”, “composition of the refrigeration system” or “refrigerant mixture” that may be used in a refrigeration system. For example, the composition may comprise an IL and a gas.

Refrigeration composition containing phosphinate IL may be suitably configured by selection of cations and anions chosen from, but not limited to, those disclosed herein.

As used herein, an “absorber” can be used interchangeably with an “absorber/reaction chamber” where the gas refrigerants and the ILs interact to form the composition of the refrigeration system.

Ionic liquids are compounds which may contain halogen, nitrogen, phosphorus, sulfur or some combination of these elements. Ionic liquid compounds may be designed with halogen, nitrogen, sulfur, phosphorus or some combinations of these elements. As used herein, an “IL” or “ionic liquid” may comprise of a single ionic liquid or a mixture of 1, 2, 3 or more ionic liquids.

Due to the large number of possible combinations of ion pairs, the ability to select the physical and chemical properties of possible IL in a refrigeration system is essentially unlimited. Functionalization of a ligand or “head”, such as by changing the length of a ligand R group, adding a ligand to different positions of a head, and/or adding a halogen to a ligand or head further increases the number of possible ILs. The head may be defined as the positively charged core atom or ring of the cation species of the IL.

In one embodiment, ILs are modified to design biodegradable and nontoxic ILs via incorporation of ethereal side chains. See for example, Greener Solvents; Room Temperature Ionic Liquids from Biorenewable Sources, Scott Handy, Chem. Eur. J. 2003, 9, 2938-2944.

As used herein, the Coefficient of Performance or (“COP”) of a temperature adjustment system, such as a refrigeration or a heat pump is a ratio of heating or cooling provided to electrical energy consumed. Higher COPs equate to lower operating costs.

As used herein, “refrigerant” is a substance or mixture of substances that may be used as a thermal energy transfer vehicle. A refrigerant, when it changes phase from liquid to vapor (evaporates), removes heat from the surroundings; and when it changes phase from vapor to liquid (condenses), adds heat to the surroundings.

As used herein, a “gas refrigerant” or a “refrigerant gas” is used interchangeably. For example, CO2 may be interchangeably referred to as a gas refrigerant or refrigerant gas. Other gas refrigerants may be selected from a group consisting of a hydrofluorocarbon, a hydrochlorofluorocarbon, a chlorofluorocarbon, a fluorocarbon, N₂, O₂, CO₂, NH₃, Ar, or H₂.

As used herein, “saturated” refers to the state of the ILs when the ILs absorbs the gas refrigerant to form a mixture of ILs and gas refrigerant. For example, a saturated IL may comprise the IL and ammonia and CO₂.

As used herein, “unsaturated” refers to the state of the ILs wherein the gas refrigerant has vaporized from the IL. For example, unsaturated IL as disclosed in the present application may comprise IL without ammonia and CO₂.

As used herein, “sparger” is a device that introduces gases into liquids through small to tiny pores. The result is greater gas/liquid contact area, which reduces the time and volume required to dissolve gas into liquid.

### DESCRIPTION OF THE FIGURE

FIG. 1 is a general depiction of an exemplary refrigeration system.

FIG. 2 is a schematic diagram of a simple vapor compression refrigeration system.

FIG. 3 is a schematic diagram of a simple absorption refrigeration system.

### EXAMPLES

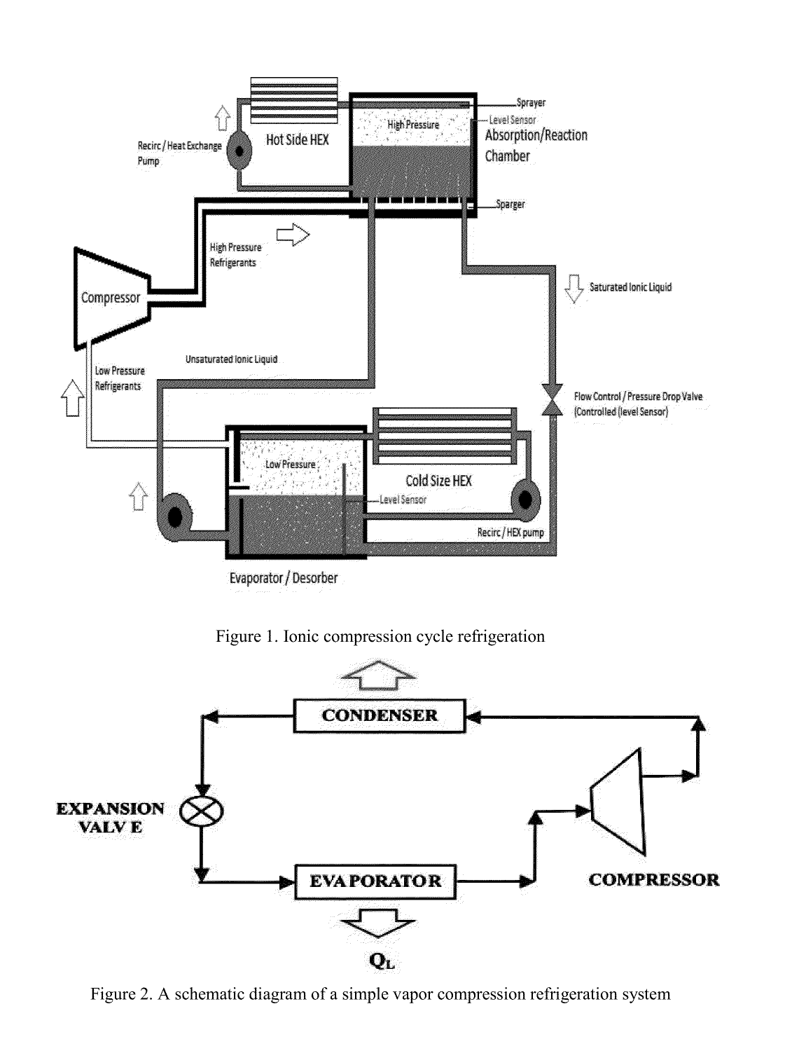

FIG. 1 illustrates an exemplary embodiment of the present application. In one aspect, the IL in the composition for the refrigeration system is1-butyl-3-methylimidazoliumbis(trifluoromethylsulfonyl)imide:

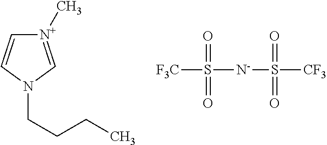

In the condenser, two gas refrigerants, ammonia and CO₂, are dissolved into ILs and react. The selection of the IL enables the reaction products to be soluble within the liquid. As the refrigerants react in the ionic fluid, further absorption from the gaseous state is facilitated due to the solubility equilibrium shift caused by the removal of each of the gas species in the IL due to the reaction between the refrigerant species. Reduction of the concentration of product caused by the pumping of product free IL from the evaporator further shifts the reaction forward and reduces the required compression work.

In FIG. 1, as representative embodiments, the following control strategy may be employed:

Cold Side Pump: Operates independently and adjusts circulation rate to maintain the desired minimum delta T between the fluid exiting the heat exchanger and the inlet temperature of the fluid into the pump.

Hot Side Pump: Operates independently and adjusts circulation rate to maintain the desired maximum delta T between the fluid exiting the heat exchanger and the inlet temperature of the fluid into the pump.

Evaporator/Desorption Pump: Operates to maintain the desired level in the desorption chamber and the absorption chamber. Level affected by the flow control valve; that may be used to drain absorption tank and fill desorption tank. Minimum flow limited by compression rate of refrigerant.

Compressor Duty: Limited by the maximum pressure and temperature allowed into the absorption tank. Limited by the maximum temperature duty required of the system.

Limited by efficiency requirements of the system. For example, as more work is done by the compressor, heat exchange increases, but efficiency falls. The controller can operate to maximize efficiency by limiting duty or vice versa.

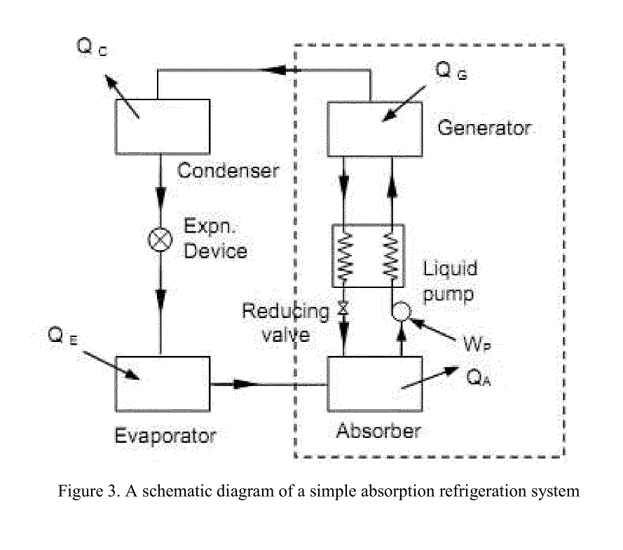

FIG. 3 illustrates an exemplary embodiment of the present application using absortion refrigeration system. The foregoing examples of the related art and limitations are intended to be illustrative and not exclusive. Other limitations of the related art will become apparent to those of skill in the art upon a reading of the specification and a study of the drawings or figures as provided herein.

While a number of exemplary embodiments, aspects and variations have been provided herein, those of skill in the art will recognize certain modifications, permutations, additions and combinations and certain sub-combinations of the embodiments, aspects and variations. It is intended that the following claims are interpreted to include all such modifications, permutations, additions and combinations and certain sub-combinations of the embodiments, aspects and variations are within their scope.

What is claimed is:

1. A refrigerant composition for use in a refrigeration system comprising:
a) water, an alcohol and compound of the formula 1, or mixtures thereof: 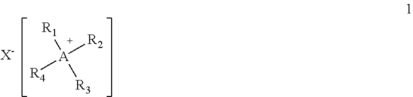
wherein A is selected from N, P or S; and wherein
i) when A is N, each R₁, R₂, R₃ and R₄ independently form a double bond with N and an adjacent R₁, R₂, R₃ or R₄ group or are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, hetero aryl and hetero aryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂; or wherein R₁, R₂ and R₃ together with N form a heteroaromatic or R₁ and R₂ together with N form a heterocyclic ring each unsubstituted or substituted by a group selected from halo, nitro, trifluoromethyl, trifluoromethoxy, methoxy, carboxy, —NH₂, —OH, —SH, —NHCH₃, —N(CH₃)₂, —SMe, cyano, (C₁-C₃)alkyl, aryl, (C₃-C₆)cycloalkyl, aryl(C₁-C₃)alkyl and heteroaryl;
ii) when A is S, R₁, R₂, R₃ and R₄ are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, hetero aryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂; and
iii) when A is P, R₁, R₂, R₃ and R₄ are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂; and
b) at least one gas refrigerant that can undergo reversible chemical reaction during refrigeration cycles.

2. The refrigerant composition of claim 1, wherein A⁺ together with R₁, R₂, R₃ and R₄ form a compound selected from the group consisting of an ammonium, imidazolium, guanidinium, pyridinium, pyridazinium, 1,2,4-triazolium, triazine, sulfonium, phosphazenium and phosphonium.

3. The refrigerant composition of claim 1, wherein the compound is of the formula 2 or 9: 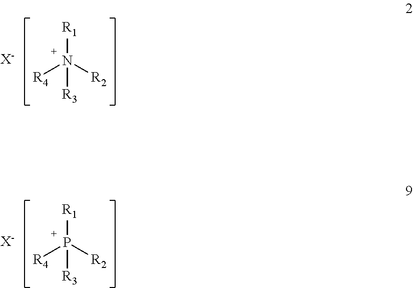
wherein for formula 2, each R₁, R₂, R₃ and R₄ independently form a double bond with N and an adjacent R₁, R₂, R₃ or R₄ group;
wherein for formula 2 and 9, R₁, R₂, R₃ and R₄ are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂;
or for formula 2, wherein R₁, R₂ and R₃ together with N form a heteroaromatic or R₁ and R₂ together with N form a heterocyclic ring each unsubstituted or substituted by a group selected from halo, nitro, trifluoromethyl, trifluoromethoxy, methoxy, carboxy, —NH₂, —OH, —SH, —NHCH₃, —N(CH₃)₂, —SMe, cyano, (C₁-C₃)alkyl, aryl, (C₃-C₆)cycloalkyl, aryl(C₁-C₃)alkyl and heteroaryl; or
wherein at least one of R₁, R₂, R₃ and R₄ is selected from the group consisting of (C₁-C₁₀)alkyl substituted with one —Cl, —Br, —I, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —OC(O)CH₂C(O)CH₃ and —CH═CR₁₀CO₂(C₁-C₃)alkyl where R₁₀ is H or CH₃; and
X⁻ is selected from the group consisting of [PF₆]⁻, [NTf₂]⁻, [BR₅R₆R₇R₈]⁻, [BF₄]⁻, OH⁻, SCN⁻, SbF₆⁻, R₉PO₄⁻, R₉SO₂⁻, R₉SO₃⁻, R₉SO₄⁻, OTf⁻, tris(trifluoromethylsulfonyl)methide, [N(CN)₂]⁻, [CH₃CO₂]⁻, [CF₃CO₂]⁻, [NO₃]⁻, Br⁻, Cl⁻, I⁻, [Al₂Cl₇]⁻, [AlCl₄]⁻, oxalate, dicarboxylates and tricarboxylate, formate, phosphate and aluminate, wherein R₅, R₆, R₇ and R₈ are each independently selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano, and wherein R₉ is selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano.

4. The refrigerant composition of claim 1 wherein the compound is of the formula 3: 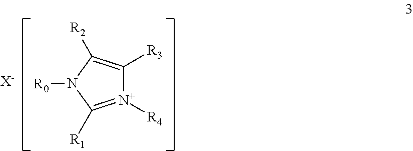
wherein:
Rₒ is selected from the group consisting of (C₁-C₅)alkyl and aryl that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂; and
R₁, R₂, R₃ and R₄ are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂; or
wherein at least one of R₀, R₁, R₂, R₃ and R₄ is selected from the group consisting of (C₁-C₁₀)alkyl substituted with one —Cl, —Br, —I, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —OC(O)CH₂C(O)CH₃ and —CH═CR₁₀CO₂(C₁-C₃)alkyl where R₁₀ is H or CH₃; and
X⁻ is selected from the group consisting of [PF₆]⁻, [NTf₂]⁻, [BR₅R₆R₇R₈]⁻, [BF₄]⁻, OH⁻, SCN⁻, SbF₆⁻, R₉PO₄⁻, R₉SO₂⁻, R₉SO₃⁻, R₉SO₄⁻, OTf⁻, tris(trifluoromethylsulfonyl)methide, [N(CN)₂]⁻, [CH₃CO₂]⁻, [CF₃CO₂]⁻, [NO₃]⁻, Br⁻, Cl⁻, I⁻, [Al₂Cl₇]⁻, [AlCl₄]⁻, oxalate, dicarboxylates and tricarboxylate, formate, phosphate and aluminate, wherein R₅, R₆, R₇ and R₈ are each independently selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano, and wherein R₉ is selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano.

5. The refrigerant composition of claim 1 wherein the compound is of the formula 4: 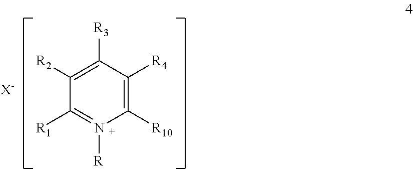
wherein R₁, R₂, R₃, R₄ and R₁₀ are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂;
R is selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂; or
wherein at least one of R, R₁, R₂, R₃, R₄ and R₁₀ is selected from the group consisting of (C₁-C₁₀)alkyl substituted with one —Cl, —Br, —I, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —OC(O)CH₂C(O)CH₃ and —CH═CR₁₀CO₂(C₁-C₃)alkyl where R₁₀ is H or CH₃; and
X⁻ is selected from the group consisting of [PF₆]⁻, [NTf₂]⁻, [BR₅R₆R₇R₈]⁻, [BF₄]⁻, OH⁻, SCN⁻, SbF₆⁻, R₉PO₄⁻, R₉SO₂⁻, R₉SO₃⁻, R₉SO₄⁻, OTf⁻, tris(trifluoromethylsulfonyl)methide, [N(CN)₂]⁻, [CH₃CO₂]⁻, [CF₃CO₂]⁻, [NO₃]⁻, Br⁻, Cl⁻, I⁻, [Al₂Cl₇]⁻, [AlCl₄]⁻, oxalate, dicarboxylates and tricarboxylate, formate, phosphate and aluminate, wherein R₅, R₆, R₇ and R₈ are each independently selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano, and wherein R₉ is selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano.

6. The refrigerant composition of claim 1 wherein the compound is of the formula 5 or 6: 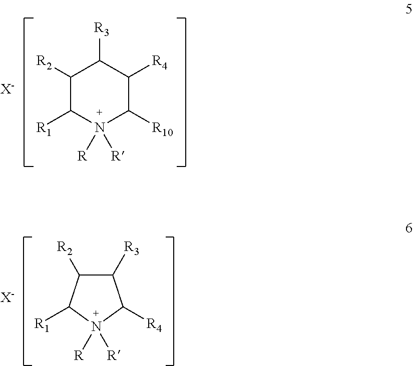
wherein R₁, R₂, R₃, R₄ and R₁₀ are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P(C₁-C₅)alkyl)₂ and —P(O)(OEt)₂; or
wherein at least one of R, R₁, R₂, R₃, R₄ and R₁₀ is selected from the group consisting of (C₁-C₁₀)alkyl substituted with one Cl, —Br, —I, CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —OC(O)CH₂C(O)CH₃ and —CH═CR₁₀CO₂(C₁-C₃)alkyl where R₁₀ is H or CH₃; and
R and R′ are independently selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂; and
X⁻ is selected from the group consisting of [PF₆]⁻, [NTf₂]⁻, [BR₅R₆R₇R₈]⁻, [BF₄]⁻, OH⁻, SCN⁻, SbF₆⁻, R₉PO₄⁻, R₉SO₂⁻, R₉SO₃⁻, R₉SO₄⁻, OTf⁻, tris(trifluoromethylsulfonyl)methide, [N(CN)₂]⁻, [CH₃CO₂]⁻, [CF₃CO₂]⁻, [NO₃]⁻, Br⁻, Cl⁻, I⁻, [Al₂Cl₇]⁻, [AlCl₄]⁻, oxalate, dicarboxylates and tricarboxylate, formate, phosphate and aluminate, wherein R₅, R₆, R₇ and R₈ are each independently selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano, and wherein R₉ is selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano.

7. The refrigerant composition of claim 1 wherein the compound is of the formula 7 or 8: 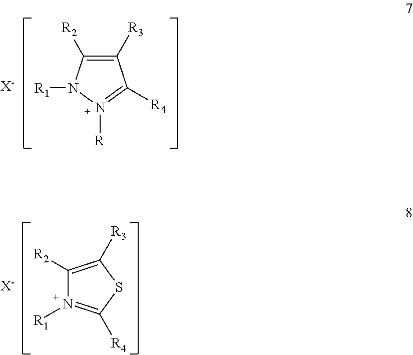
wherein:
R is selected from the group consisting of (C₁-C₅)alkyl and aryl that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂; and
R₁, R₂, R₃ and R₄ are each independently selected from the group consisting of hydrogen, (C₁-C₂₀)alkyl, aryl, (C₃-C₁₀)heterocyclyl, (C₃-C₁₀)cyclo alkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂; or
wherein at least one of R, R₁, R₂, R₃ and R₄ is selected from the group consisting of (C₁-C₁₀)alkyl substituted with one —Cl, —Br, —I, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —OC(O)CH₂C(O)CH₃ and —CH═CR₁₀CO₂(C₁-C₃)alkyl where R₁₀ is H or CH₃; and
X⁻ is selected from the group consisting of [PF₆]⁻, [NTf₂]⁻, [BR₅R₆R₇R₈]⁻, [BF₄]⁻, OH⁻, SCN⁻, SbF₆⁻, R₉PO₄⁻, R₉SO₂⁻, R₉SO₃⁻, R₉SO₄⁻, OTf⁻, tris(trifluoromethylsulfonyl)methide, [N(CN)₂]⁻, [CH₃CO₂]⁻, [CF₃CO₂]⁻, [NO₃]⁻, Br⁻, Cl⁻, I⁻, [Al₂Cl₇]⁻, [AlCl₄]⁻, oxalate, dicarboxylates and tricarboxylate, formate, phosphate and aluminate, wherein R₅, R₆, R₇ and R₈ are each independently selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano, and wherein R₉ is selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano.

8. The refrigerant composition of claim 1 wherein the compound is of the formula 10: 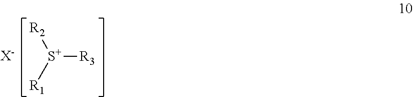
wherein R₁, R₂ and R₃ or are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, hetero aryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P(C₁-C₅)alkyl)₂ and —P(O)(OEt)₂; and
X⁻ is selected from the group consisting of [PF₆]⁻, [NTf₂]⁻, [BR₅R₆R₇R₈]⁻, [BF₄]⁻, OH⁻, SCN⁻, SbF₆⁻, R₉PO₄⁻, R₉SO₂⁻, R₉SO₃⁻, R₉SO₄⁻, OTf⁻, tris(trifluoromethylsulfonyl)methide, [N(CN)₂]⁻, [CH₃CO₂]⁻, [CF₃CO₂]⁻, [NO₃]⁻, Br⁻, Cl⁻, I⁻, [Al₂Cl₇]⁻, [AlCl₄]⁻, oxalate, dicarboxylates and tricarboxylate, formate, phosphate and aluminate, wherein R₅, R₆, R₇ and R₈ are each independently selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano, and wherein R₉ is selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, —SMe and cyano.

9. A refrigerant composition for use in a refrigeration system comprising:
a) an ionic liquid compound of the formula 11: 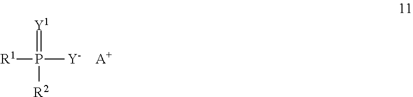
wherein:
Y and Y¹ are each independently selected from O or S;
R¹ and R² are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two halo, —NO₂, CF₃—, CF₃O—, CH₃O—, —CO₂H, —NH₂, —OH, —SH, —NHCH₃, —N(CH₃)₂, —CN, —SMe, —SO₃H, —CH═CH₂, —CH₂CH═CH₂, —P((C₁-C₅)alkyl)₂ and —P(O)(OEt)₂, or mixtures of the substituents;
A⁺ is a cation selected from the group consisting of an ammonium, imidazolium, guanidinium, pyridinium, pyridazinium, 1,2,4-triazolium, triazine, sulfonium, phosphazenium and phosphonium cation; and
b) at least one gas refrigerant that can undergo reversible chemical reactions during refrigeration cycles.

10. The refrigerant composition of claim 9, wherein A⁺ is an ammonium cation of the formula 12: 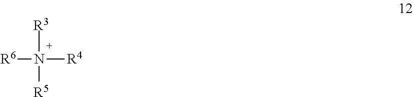
wherein R³, R⁴, R⁵ and R⁶ are each independently a bond or are selected from the group consisting of hydrogen, CF₃, —C₂F₅, —C₃F₇, —C₄F₉, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two Cl, —Br, —I, —NO₂, CF₃O—, CH₃O—, —CO₂H, —NH₂, —OH, —SH, —NHCH₃, —N(CH₃)₂, —CN, —SMe, —SO₃H, CF₃, —C₂F₅, —C₃F₇, —C₄F₉, CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —P((C₁-C₅)alkyl)₂, —P(O)(OEt)₂, —OC(O)CH₂C(O)CH₃ and —CH═CR₁₀CO₂(C₁-C₃)alkyl, where R₁₀ is H or CH₃, or mixtures of the two substituents.

11. The refrigerant composition of claim 10, wherein the compound of the formula 12 is selected from the group consisting of: 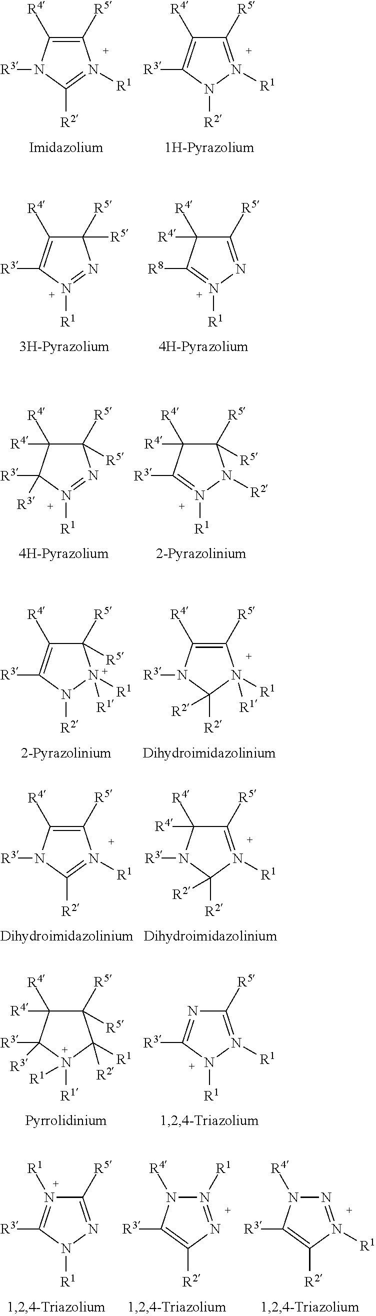 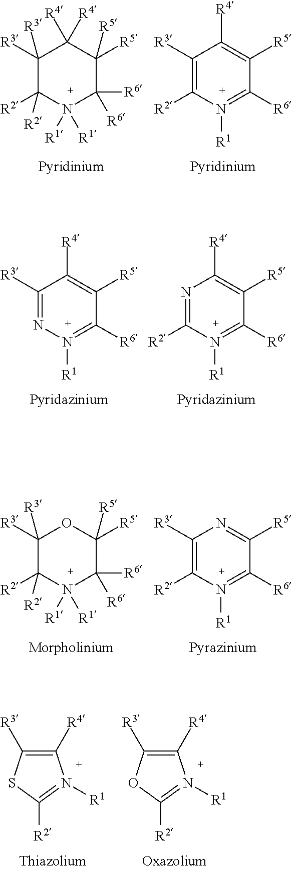
wherein:
each R¹, R^{1′}, R², R^{2′}, R³, R^{3′}, R⁴, R^{4′}, R⁵, R^{5′}, R⁶ and R^{6′} is independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two halo, —NO₂, CF₃—, CF₃O—, CH₃O—, —CO₂H, —NH₂, —OH, —SH, —NHCH₃, —N(CH₃)₂, —CN, —SMe, —SO₃H, —CH═CH₂, —CH₂CH═CH₂, —P((C₁-C₅)alkyl)₂ and —P(O)(OEt)₂, or mixtures of the two substituents.

12. The refrigerant composition of claim 9 wherein the compound is of the formula 11a: 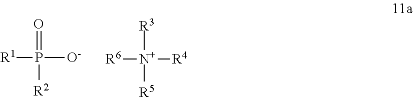
wherein:
R¹ and R² are each independently selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two halo, —NO₂, CF₃—, CF₃O—, CH₃O—, —CO₂H, —NH₂, —OH, —SH, —NHCH₃, —N(CH₃)₂, —CN, —SMe, —SO₃H, —CH═CH₂, —CH₂CH═CH₂, —P((C₁-C₅)alkyl)₂ and —P(O)(OEt)₂, or mixtures of the substituents; and
wherein R³, R⁴, R⁵ and R⁶ are each independently a bond or are selected from the group consisting of hydrogen, —CF₃, —C₂F₅, —C₃F₇, —C₄F₉, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two —Cl, —Br, —I, —NO₂, CF₃O—, CH₃O—, —CO₂H, —NH₂, —OH, —SH, —NHCH₃, —N(CH₃)₂, —CN, —SMe, —SO₃H, —CF₃, —C₂F₅, —C₃F₇, —C₄F₉, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —P((C₁-C₅)alkyl)₂, —P(O)(OEt)₂, —OC(O)CH₂C(O)CH₃ and —CH═CR₁₀CO₂(C₁-C₃)alkyl, where R₁₀ is H or CH₃, or mixtures of the two substituents; or
wherein N⁺ together with R³, R⁴, R⁵ and R⁶ form a cation selected from the group consisting of ammonium, imidazolium, guanidinium, pyridinium, pyridazinium and 1,2,4-triazolium, each of which is unsubstituted or substituted by one or two substituents selected from the group consisting of —Cl, —Br, —I, —NO₂, CF₃O—, CH₃O—, —CO₂H, —NH₂, —OH, —SH, —NHCH₃, —N(CH₃)₂, —CN, —SMe, —SO₃H, —CF₃, —C₂F₅, —C₃F₇, —C₄F₉, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —P((C₁-C₅)alkyl)₂, —P(O)(OEt)₂, —OC(O)CH₂C(O)CH₃ and —CH═CR₁₀CO₂(C₁-C₃)alkyl, where R₁₀) is H or CH₃, or mixtures of the two substituents.

13. The refrigerant composition according to claim 9, wherein the compound of the formula 11a is selected from a group consisting of

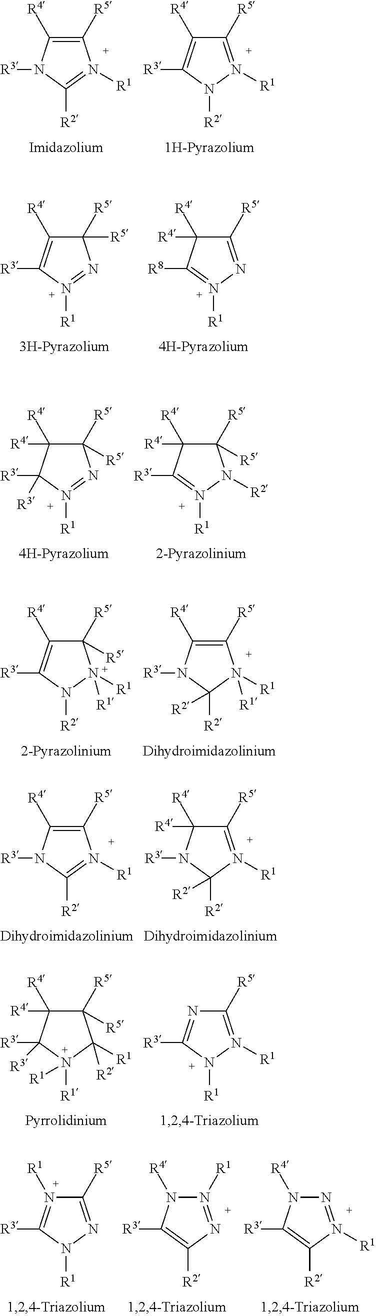

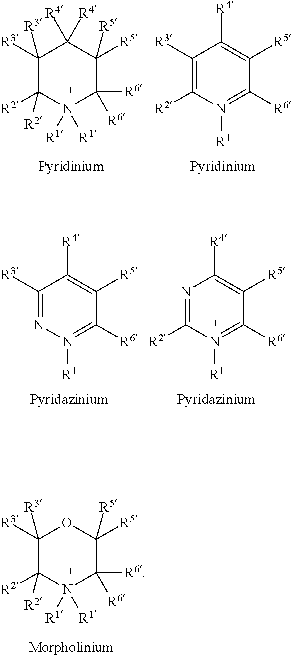

14. The refrigerant composition of claim 1, wherein the composition further comprises a second ionic liquid, water and alcohol, or mixture thereof.

15. The refrigerant composition of claim 1, wherein the gas refrigerants is selected from an acidic gas and a basic gas;
wherein the basic gas refrigerant is selected from a group consisting of methylamine, ethylamine and ammonia; or a combination thereof; and
wherein the acidic gas refrigerant is selected from a group consisting of carbon dioxide, nitrous dioxide and sulfur dioxide; or a combination thereof.

16. The refrigerant composition of claim 1, wherein the gas refrigerant is ammonia and carbon dioxide.

17. The refrigerant composition of claim 1, wherein the refrigerant composition further comprises additives selected from a group consisting of corrosion inhibitors, anti-foaming agents, and antioxidants; and any combination thereof.

18. A refrigeration system comprising a refrigerant composition and an apparatus, wherein the refrigerant composition comprises at least one gas refrigerant and a working liquid selected from the group consisting of water, alcohol, ionic liquids and mixtures thereof;
wherein the compression refrigeration apparatus comprises:
(a) an absorption/reaction chamber configured to receive the gas refrigerant that is passed from a compressor into the absorption/reaction chamber;
wherein the compressor is optionally an oil-lubricated compressor or an oil-free compressor;
(b) an evaporator/desorber chamber configured to pass an unsaturated working liquid to the absorption/reaction chamber;
wherein the one or more gas refrigerants reversibly react in the absorption/reaction chamber under high pressure and absorbed by the unsaturated working liquid to form a saturated working liquid;
(c) a hot side heat exchanger configured to be connected to the absorption/reaction chamber, where heat is removed from the refrigeration composition;
(d) a pressure reduction device configured to receive the saturated working liquid from the absorption/reaction chamber and to pass the saturated working liquid to the evaporator/desorption chamber;
wherein the pressure reduction device comprise a valve or a capillary tube;
wherein the gas refrigerant vaporizes from the saturated working liquid under low pressure in the evaporator/desorption chamber to form the unsaturated working liquid;
(e) a cold side heat exchanger configured to be connected to the evaporator/desorption chamber, where heat is absorbed by the refrigeration composition; and
(f) a conduit configured to receive the gas refrigerant from the evaporator/desorption chamber and to return the gas refrigerant to the compressor.

19. A refrigeration system comprising a refrigerant composition and an apparatus, wherein the refrigerant composition comprises one or more gas refrigerants and a working liquid selected from the group consisting of water, alcohol, an ionic liquid or mixtures thereof;
wherein the apparatus executes an absorption refrigeration cycle by:
(a) forming in an absorber a refrigeration composition of gas refrigerants and an ionic liquid, where the gas refrigerant is selected from the group consisting of an acidic gas and a basic gas;
(b) passing the refrigeration composition to a generator where the refrigeration composition is heated to vaporize the gas refrigerant from the working liquid;
(c) passing the gas refrigerant, in vapor form, to a condenser where the gas refrigerant is condensed under pressure to a liquid;
(d) passing the gas refrigerant, in liquid form, through a pressure reduction device, to an evaporator where the gas refrigerant, in liquid form, is evaporated under reduced pressure, in proximity to the object or space to be cooled; and
(e) passing the gas refrigerant, in vapor form, to the absorber.

20. The refrigeration system of claim 18 or 19, wherein the refrigerant composition for the refrigeration system is a refrigeration composition comprising:
a) water, an alcohol and compound of the formula 1, or mixtures thereof: 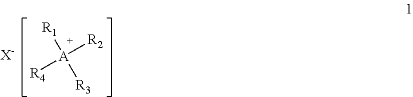
wherein A is selected from N, P or S; and wherein
i) when A is N, each R₁, R₂, R₃ and R₄ independently form a double bond with N and an adjacent R₁, R₂, R₃ or R₄ group or are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂; or wherein R₁, R₂ and R₃ together with N form a heteroaromatic or R₁ and R₂ together with N form a heterocyclic ring each unsubstituted or substituted by a group selected from halo, nitro, trifluoromethyl, trifluoromethoxy, methoxy, carboxy, —NH₂, —OH, —SH, —NHCH₃, —N(CH₃)₂, —SMe, cyano, (C₁-C₃)alkyl, aryl, (C₃-C₆)cycloalkyl, aryl(C₁-C₃)alkyl and heteroaryl;
ii) when A is S, R₁, R₂, R₃ and R₄ are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂; and
iii) when A is P, R₁, R₂, R₃ and R₄ are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group that may be unsubstituted or substituted by one or two halo, nitro, trifluoromethyl, trifluoromethoxy, methoxy, carboxy, —NH₂, —OH, —SH, —NHCH₃, —N(CH₃)₂, cyano, —SMe, —SO₃H, —P((C₁-C₅)alkyl)₂ and —P(O)(OEt)₂; and
b) at least one gas refrigerant that can undergo reversible chemical reaction during refrigeration cycles.
